(19) United States
(12) Patent Application Publication
(10) Pub. No.: US 2026/0212047 A1
(43) Pub. Date: Jul. 23, 2026

(54) DIGITAL RIGHTS MANAGEMENT ARCHITECTURE FOR ARTIFICIAL INTELLIGENCE MODELS

(71) Applicant: Microsoft Technology Licensing, LLC, Redmond, OH (US)

(72) Inventors: Eran ARBEL, Redmond, WA (US); Hanan GRINBERG, Redmond, WA (US); Gilad PUNDAK, Redmond, WA (US); Orr SROUR, Redmond, WA (US); Amir ZYSKIND, Redmond, WA (US)

(21) Appl. No.: 19/035,396

(22) Filed: Jan. 23, 2025

(51) Int. Cl. G06F 21/62; G06F 21/12

(52) U.S. Cl. CPC G06F 21/629; G06F 21/12

(57) ABSTRACT

Various technologies pertaining to digital rights management (DRM) for artificial intelligence (AI) models are provided. In an example, a client computing device comprises a first processor and one or more second processors. Subsequent to transmitting a request for access to a computer-implemented AI model, the client computing device receives an encryption key, AI model certification information, and an AI model payload, wherein the AI model payload comprises an encrypted AI model. The client computing device validates the AI model payload based upon the AI model certification information and decrypts the AI model payload. The client computing device stores the decrypted AI model payload in a second memory where a first memory stores a DRM application. Responsive to a request to execute the AI model stored in the second memory, the computing device causes execution of the AI model by the one or more second processors.

### BACKGROUND

Artificial intelligence (AI) models are computer-implemented models that generate complex outputs based upon training data over which the AI model has been trained. There are many different types of AI models that can be tailored to perform certain tasks. One example of an AI model is a large language model (LLM), which receives a structured input (sometimes referred to as a “prompt”) as input and in near real-time (e.g., within a few seconds of receiving the input) generates an output that is responsive to the input prompt. The output generated by the LLM is often human readable text, but some models can also produce output in the form of executable source code, images, music, video, etc. In general, the model processes the input as a sequence of tokens and generates an output based upon a contextual inference of the model. Each successive output token is generated in part based upon its preceding token(s). The model retains the information from each successive input-output sequence which enables a conversational interaction with the model.

Another example of an AI model is a computer vision model. Computer vision models can analyze image data to identify and classify objects within an image, track objects in video, or perform optical character recognition to identify textual data within an image. Regardless of the type of AI model, the number of parameters within the trained model is often in the billions. While this enables the models to produce sophisticated output based upon large-scale training data, the computing resources required by the computing system executing the AI model are significant. More specifically, the implementation architecture of the AI model contributes to the significant computing resources required at the time of execution of the model.

Due to the complexity of AI models and the significant demand on computing resources needed to execute a model, AI models are conventionally executed remotely using distributed computing resources, i.e., in the cloud. However, execution of AI models in the cloud is undesirable in certain situations, for example, in applications where persistent network access is unavailable or unreliable. As a further example, cloud execution of an AI model may also be undesirable for applications where low latency is needed for critical operations, such as manufacturing, interactive gaming, live video processing, etc. Cloud execution of an AI model may further be undesirable in certain situations where data privacy and data security policies require localized data that cannot be uploaded to cloud-based services.

Due to the rising popularity of AI models, there has been significant effort made to move from cloud-based execution to enabling execution of models on local computing devices or so-called “edge” devices. However, even for AI models that can be executed locally, there exists several potential areas for misappropriation of the model or vulnerabilities that could expose the model and/or the computing system executing the model. For example, transmitting the AI model from the model owner/provider to an external computing system can attract malicious actors that wish to steal or corrupt the model. When an AI model is executed in the cloud it is distributed across disparate resources, making it much more difficult to misappropriate the model. Conventionally, when a model is locally stored on an external computing system, the model owner lacks control over the custody of the model and its execution. Moreover, specific model weights or other proprietary information associated with the model (e.g., inputs, outputs, configuration information, etc.) may be exposed to non-secure portions of an external computing system such that they would be accessible to malicious actors. These vulnerabilities associated with conventional local execution of AI models discourage adoption of AI models in applications where local execution of the model is desirable.

### SUMMARY

The following is a brief summary of subject matter that is described in greater detail herein. This summary is not intended to be limiting as to the scope of the claims.

Various technologies pertaining to digital rights management (DRM) for artificial intelligence (AI) models are described herein. In general, as discussed herein, DRM pertains to the way that the described technologies control access to and execution of AI model assets. It is appreciated that while described in the context of AI models, the described technologies are compatible with any type of computer-implemented model or application in which the operational control and secure execution provided by the described DRM technologies would be appreciated. As described herein, an exemplary DRM system comprises at least a server computing system associated with the provider of one or more AI models (e.g., a provider computing system) and a client computing device where local execution of an AI model is desired. As used herein, it is appreciated that execution of an AI model encompasses accessing one or more aspects of an AI model (e.g., model parameters, model weights, and/or other model data) to cause the AI model to generate output. In some examples, an AI model may comprise a set of configuration information, parameters, or the like that configure a device or application to process input into a complex output. It is an aspect of the disclosed technologies that an AI model provided by the provider computing system is configured to operate according to parameters set forth by the provider. Such controlled execution of the AI model enables secure and trusted execution of an AI model locally at the external computing system.

As will be discussed in further detail herein, there are several different scenarios where local execution of an AI model is advantageous. For example, in certain applications, persistent access to the Internet is unavailable and/or unreliable. In such cases, conventional execution of an AI model over a cloud-based service is difficult or impossible. As is an aspect of the presently described DRM technologies, a network connection is needed only during the initial download of an AI model. The AI model is then free to operate at the local client device according to the policies and configuration set forth by the provider of the AI model. In another example, the latency tolerance for specific applications is incompatible with cloud execution of an AI model. For example, in many manufacturing contexts, the latency associated with cloud-based execution of an AI model is unsuitable for integration within existing manufacturing processes which move quickly. In another example, the latency associated with cloud-based execution of an AI model is unsuitable for applications which require real-time or near real-time processing such as interactive gaming, live video processing, or the like.

Local execution of the model is significantly lower latency than a cloud-based execution, enabling use of certain models in a wide variety of applications that would otherwise be impractical. And yet another example, in certain applications, the sensitivity of the input data and/or the resulting output data may warrant additional security and control necessitating local execution of the AI model. By executing the AI model locally, outputs of the model may be retained securely on-device (or within a secure internal network) and not exposed during networked exchange of data.

It is a further aspect of the technologies described herein that the provider computing system maintains a data store of different AI models that can be transmitted to external computing systems for local execution. In some examples, the provider computing system stores models that are designed in whole or in part by third parties. It is appreciated that the technologies herein are readily adaptable for use with AI models owned and/or developed by the provider as well as third parties. In some examples, the AI models may be optimized or otherwise modified by the provider for execution on a client computing device.

The provider computing system is configured to structure the transmission of the AI model such that the execution environment needed to access the AI model must comply with parameters and configuration details dictated by the provider computing system. In an example, the provider computing system encrypts the AI model (and/or any other data associated with the AI model) such that only the intended recipient can execute the model. Accordingly, even if a malicious actor obtains a copy of the encrypted model, the model is not executable without the proper model key provided by the provider computing system. In another example, the execution of the AI model is controlled according to the parameters and configuration details provided by the provider of the model. Specifically, these constraints serve to control access to the AI model such that the model is only able to be executed according to the security and/or performance standards established by the provider and/or third parties.

Certain functionality of the technologies described herein are illustrated through the following examples. In general, the operation of the described technologies can be described in two parts. First, the preparation and secure transmission of an AI model (and/or data associated with the model, configuration information, certification information, etc.) from a computing system operated by an AI model provider to one or more client computing devices. And second, once the AI model has been downloaded to a client computing device, securely executing the AI model at the client computing device according to the configuration parameters set forth by the model provider. Optionally, according to policies set forth by the AI model provider, there may also be a revocation process wherein access to the AI model is revoked and the AI model (and/or associated data) is removed/deleted from or otherwise made inaccessible to the client computing device.

In a first example, a server computing system comprises a processor and a memory. The server computing system is associated with a provider of AI models. Accordingly, as referred to herein, the server computing system may also be referred to as a provider computing system. The AI model provided by the provider by way of the server computing system may be developed by the provider (e.g., proprietary models), may be developed by one or more third party developers, or may be developed by a third-party developer and modified by the provider. Different AI models provided by the server computing system are stored in an AI model data store.

The memory of the server computing system stores a server digital rights management (DRM) application that, when executed by the processor, causes the processor to execute the server DRM application and perform certain functionalities associated with the server DRM application. Specifically, the server DRM application enables the server computing system to securely transmit an AI model to a client computing device and ensure that the model will be protected such that only an authorized party can access and use the model. Unlike conventional digital rights management for data like music and movies, where the value in the data is necessarily linked to the entire file, effective management of an AI model must protect individual aspects of the model (e.g., model weights, model graphs, input/output data, etc.) and apply more granular control over the execution of the model in order to prevent misappropriation of these aspects of the model.

The server computing system further comprises an encryption module and a certification module. The encryption module is configured to encrypt information (e.g., the AI model and any associated data, configuration information, etc.) for secure transmission to a client computing device for use at the client computing device. The encryption module can use symmetric encryption (using a single key for both encryption and decryption) and/or asymmetric encryption (using a pair of keys, one public and one private). In one example, once a secure connection (e.g., a secured transport layer security (TLS) channel) is made between the server computing system and the client computing device, the server computing system and the client computing device will exchange public keys. As an example, the server computing system encrypts a model key (M) (e.g., a symmetric encryption model key, such as a model AES key, or an asymmetric decryption model key (e.g., public RSA key, public ECC key, etc.)). The model key (once decrypted) can be used to access certain aspects of the AI model, for example, by decrypting the AI model (or portions thereof). In some examples, the server computing system uses the client computing device's public key (C_{pub})(e.g., public encryption key (RSA, ECC, etc.)) to encrypt the model key resulting in an encrypted model key, represented as ENC(C_{pub}, M). This encrypted (or wrapped) model key may then be decrypted (unwrapped) at the client computing device using the client computing device's corresponding private key (asymmetric encryption), represented as DEC(Cₚᵣᵢ, ENC(C_{pub}, M)) [symbol] M.

In another example, the model key M is encrypted at the server computing system using a first layer of encryption (e.g., using the client computing device's public key, C_{pub}) and a second layer of encryption (e.g., using the server computing system's private key, Sₚᵣᵢ). This double-encrypted (or doubly wrapped) model key is then able to be decrypted at the client computing device using the client computing device's private key, Cₚᵣᵢ and the server computing system's public key, S_{pub}. The double wrapping may be done in either order, such as ENC(C_{pub}, ENC(Sₚᵣᵢ, M)) or ENC(Sₚᵣᵢ, ENC(C_{pub}, M)), with the unwrapping occurring in the corresponding inverse order to obtain the model key, e.g., DEC(S_{pub}, DEC(Cₚᵣᵢ, ENC(C_{pub}, ENC(Sₚᵣᵢ, M)))), or DEC(Cₚᵣᵢ, DEC(S_{pub}, ENC(Sₚᵣᵢ, ENC(C_{pub}, M)). Additional layers of wrapping (and unwrapping) may be applied. It is appreciated that the various encryption/decryption methodologies described herein may be applied to any data transmitted between the server computing system and one or more computing devices. In some examples, the AI model itself is encrypted using a first type of encryption and its corresponding model key is encrypted using a second type of encryption. Other data (e.g., certification information, etc.) transmitted between the server computing system a client computing device may also be encrypted in a similar manner. In some examples, the model key may be unique per client computing device, or generic to the provider of the AI model. In certain examples, the model key is hardware enforced by hardware of the client computing device and/or by a software configuration state of the client computing device (client operating system configuration, etc.)

In one example, the model key and the model certification information are transmitted separately from the AI model payload (which comprises the AI model and any additional data associated with the model). When the model payload is transmitted to/downloaded by the client computing device, the client computing device can validate the AI model. Validation of the AI model can include, for example, verifying one or more attestations of the model, verifying one or more certificates associated with the model, verifying an access level associated with the model (e.g., according to one or more licenses), verifying a digital signature of the model, verifying an execution environment of the client computing device, etc. In some examples, validation allows the client computing device to verify that the downloaded AI model is the authentic version of the model that was requested. In some examples, validation of the AI model by the client computing device can detect that the model has been modified or otherwise tampered with, which may be indicative of malicious activity. In another example, validation of the AI model confirms that the client computing device can operate the appropriate execution environment needed to access the AI model. Upon successfully completing the validation process, the client computing device may store the AI model. In one example, the client computing device stores the AI model in decrypted form in a secure memory. In another example, the client computing device stores the encrypted AI model with the model key secured by a secure hardware element (e.g., sealing and/or binding the model key to a hardware trusted platform module (TPM) or Trusted Execution Environment (TEE), securely stored within a secure access module (SAM), or the like).

An exemplary client computing device has a first processor and one or more second processors. In some examples, the first processor is a central processing unit (CPU). In certain examples, the one or more second processors is at least one of a graphical processing unit (GPU) or a neural processing unit (NPU). In some examples, the first processor and the one or more second processor may be distinctive cores of a single processor, so long as the distinctive cores are not in operable communication with one another. In one example, the one or more second processors form a trusted execution environment (TEE). A TEE is isolated from the main operating system and other applications which prevents interaction between these aspects of the client computing device and the AI model being executed within the TEE.

The client computing device further comprises a first and a second memory. In some examples the first memory is system memory of the client computing device while the second memory is a secure memory not accessible certain parts of the client computing device (e.g., the first processor). In some examples, the second memory is associated with the one or more second processors (e.g., a processor of the one or more second processors is a GPU with dedicated GPU memory, a processor of the one or more second processors is an NPU with dedicated NPU memory, etc.).

By dividing certain execution tasks between the first processor and the one or more second processors, the AI model can be executed by the client computing device securely without exposing sensitive portions of the model to less secure areas of the client computing device. In one example, a first processor (CPU) can make a call for the model to be used, for example, by way of a high-level application (e.g., a client DRM application), however, sensitive portions of the model (e.g., model graphs, model weights, model embeddings, model command packets, model OP codes, model topography, model structure, input/output data, etc.) will not be accessible to the first processor. Instead, the one or more second processors will consume the AI model from the secure memory according to configuration parameters set forth by the provider. In some embodiments, the output of the AI model is written back to the secure memory. In other examples, the output may be written to secure or non-secure memory locations (locally at the client computing device, or elsewhere).

By way of example, during operation, the process of accessing an AI model at the client computing device begins with the client computing device transmitting to the server computing system (e.g., by way of a network) a request for access to a computer-implemented AI model. The AI model can be any AI model, AI agent, or the like. In some examples, the AI model is a generative language model (GLM) such as a large language model (LLM) or a small language model (SLM). In other examples, the AI model is a computer vision model, interactive gaming model, video editing model, or the like. It is appreciated that while generally discussed herein with respect to AI models, in some examples, the described DRM system is equally compatible with any computer-implemented model or application. In certain examples, the AI model is optimized for execution on a client computing device (as opposed to execution in the cloud).

Responsive to positive acknowledgement of the request, a secure network connection (e.g., over the Internet) is established between the server computing system and the client computing device. In some examples, the secure connection is a secured transport layer security (TLS) channel. Once the secure connection is established, the server computing system and the client computing device exchange encryption keys. The server computing system encrypts the AI model key using the key received from the client computing device. In one example, the encrypted model key, along with certification information and/or model configuration parameters set by the provider of the AI model, are transmitted to the client computing device. Separately, the encrypted model payload, which comprises the AI model (and any data associated with the model), is transmitted to the client computing device.

Upon receipt of the AI model payload, in some examples, the client computing device validates the model. During validation of the model, the client computing device verifies certain aspects of the AI model payload. For example, the client computing device may verify one or more certificates associated with the model, check a digital signature of the model, verify one or more attestations of the model, verify an execution environment, etc. Once the model is validated, the client computing device may decrypt the model for storage at a secure memory location of the client computing device, secure the model key for use in an execution environment (e.g., secure the model key using a SAM, bind the model key to the validated execution environment, configure secure memory and store the model key within that secure memory, etc.). In one example, the client computing device first decrypts the model key that it received encrypted from the server computing system. The client computing device then uses the decrypted model key to decrypt the AI model and access aspects of the AI model. The decrypted model is then stored in secured memory. In some examples, the client computing device performs inline encryption as the model is transferred to the secured memory.

To execute the AI model stored in the secure memory, the first processor (e.g., CPU) sends a request by way of an application (e.g., a client DRM application) to a second processor (e.g., GPU, NPU, etc.) that is configured to execute the AI model. The request may include information relating to the model such as which model needs to be executed (e.g., the name or identifier associated with a model), how much memory is needed for execution of the model, etc.). The second processor then reads model parameters from the secure memory and executes the model. In some examples, the information retrieved from the secure memory is inline decrypted while being read. In certain examples, the second processor executes certain functionality of the AI model using information stored in the secure memory and information stored in other memory associated with client computing device. The resulting output of the AI model is then stored at the client computing device, either in secured memory and/or in non-secured memory.

While generally described with respect to AI models, it is appreciated that the digital rights management methodologies described herein have further advantageous application in other computing contexts, for example, facilitating secure transfer and managed local execution of other computer-implemented models or other types of computer-executed applications.

The above presents a simplified overview of the various technologies described herein in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system for DRM of AI models.

FIG. 2 is a functional block diagram of an exemplary system for DRM of AI models after an AI model has been transmitted and stored at a client computing device.

FIG. 3 is a functional block diagram of another exemplary system for DRM of AI models.

FIG. 4 is a flow diagram that illustrates an example methodology for storing an AI model according to the technologies disclosed herein.

FIG. 5 is a flow diagram that illustrates another example methodology for executing an AI model according to the technologies disclosed herein.

FIG. 6 depicts an example computing device.

Various technologies pertaining to a digital rights management for AI models is described herein and are now described with reference to the drawings, wherein like reference numerals are used to refer to like elements throughout.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

Various technologies pertaining to digital rights management (DRM) for artificial intelligence (AI) models are described herein. The described DRM system presents various advantages over conventional technologies for executing AI models. As noted above, conventional AI models are executed in a cloud environment, which suffers from numerous limitations and limits applicability of AI models in certain applications. For example, conventional cloud-based execution of AI models requires a stable and fast network connection. In certain applications where persistent network access is unreliable or altogether unavailable, conventional AI models cannot be used. Additionally, a further drawback of conventional cloud-based AI model execution relates to demand bottlenecks. For example, when multiple users are engaging with a cloud-based model, there may be a strain on the model provider's resources such that the increased demand may severely increase operational latency of the model and/or cause certain users to be shut out from accessing the model.

Additionally, conventional cloud-based execution of AI models is associated with unacceptable latency for certain applications such as manufacturing, interactive gaming, live video processing, etc. Local execution of the model offers significantly lower latency than a cloud-based execution, enabling use of certain models in a wide variety of applications that would otherwise be impractical. And yet another example, in certain applications, the sensitivity of the input data and/or the resulting output data may warrant additional security, privacy, and control necessitating local execution of the AI model. By executing the model locally, outputs of the model may be retained securely on-device and not exposed during networked exchange of data. Conventional cloud-based AI models are also significantly expensive, both in the computing resources required to host and execute the model in the cloud, but also with respect to operational costs associated with such execution.

As will be described in greater detail with reference to the drawings, the described digital rights management system improves over conventional cloud-based AI model technologies by 1) eliminating the need for persistent network access to execute an AI model; 2) reducing the resources required to execute an AI model; 3) enabling use of AI models in a broader range of applications where input/output data cannot be securely transmitted remotely; and 4) enhancing control of an AI model execution environment. These and other improvements over conventional technologies will be appreciated through the following description of exemplary systems and methods.

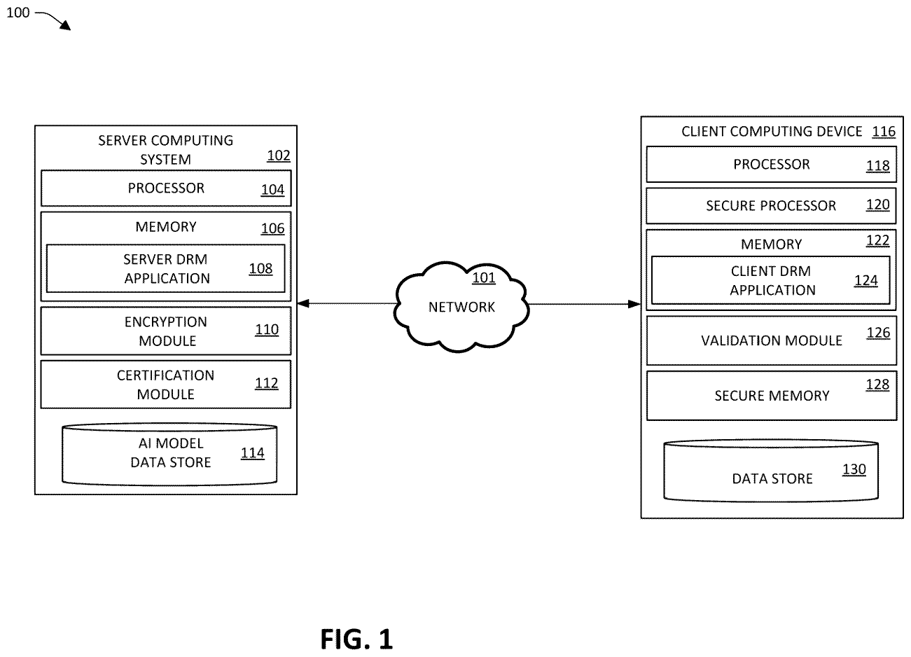

With reference to FIG. 1, an example system 100 is illustrated. System 100 is a DRM system for AI models which manages the access and usage rights pertaining to one or more AI models. System 100 further facilitates secure transfer of an AI model from a provider computing system to a client computing device for local execution at the client computing device. The system 100 comprises at least a server computing system 102 and client computing device 116. The server computing system 102 and client computing device 116 are operably connected by way of network 101 (e.g., the Internet, intranet, or the like). The server computing system 102 facilitates the secure transfer of an AI model to client computing device 116 for local execution on device. As used herein, execution of an AI model encompasses accessing one or more aspects of the AI model (e.g., model parameters, model weights, and other model data) used to cause the AI model to generate output. In some examples, an AI model may comprise a set of configuration information, parameters, or the like that configure a device or application to process input into a complex output.

Server computing system 102 comprises a processor 104 and a memory 106. Processor 104 may include one or more processor cores to process computer-executable instructions (e.g., stored in memory 106), such that, when executed, cause the processor 104 to perform certain functionality as described with reference to server computing system 102 and/or its component parts. Memory 106 can be a dynamic random access memory (DRAM) device, a static random access memory (SRAM) device, flash memory device, phase-change memory device, or some other memory device suitable to serve as process memory. For example, memory 106 stores a server DRM application 108. The server DRM application 108 comprises instructions that, when executed by the processor 104, cause the processor 104 to execute the server DRM application 108 and perform certain functionalities associated with the server DRM application 108. Specifically, the server DRM application 108 enables the server computing system 102 to securely transmit an AI model to a client computing device 116 and ensure that the model will be protected such that only an authorized party can access and use the model. Unlike conventional digital rights management for data like music and movies, where the value in the data is necessarily linked to the entire file, effective management of an AI model must protect individual aspects of the model (e.g., model weights, model graphs, model embeddings, model command packets, model OP codes, model topology, model structure, input/output data, etc.) and apply more granular control over the execution of the model in order to prevent misappropriation of these aspects of the model.

The server DRM application 108 facilitates transfer of one or more AI models (and any associated data) from the server computing system 102 to one or more external systems (e.g., client computing device 116). Additionally, DRM application 108 may configure usage parameters that control the execution environment permitted to access an AI model (e.g., number processor cores, type of processors (GPU, NPU, etc.), amount of available memory, type of memory, security requirements, etc.). In one example, the usage parameters configured by the DRM application 108 permit access to a model only if the model is executed within a trusted execution environment (TEE). A TEE is isolated from the main operating system and other applications which prevents interaction between these aspects of the client computing device 116 and the AI model being executed within the TEE. In some examples, the TEE is formed by way of a separate processor and memory distinct from the processor and memory used to execute the operating system. In some examples, the TEE is formed by way of logical separation of portion of processor and/or memory resources to segregate the TEE from other processing activity at the operating system level. In one example, a TEE may exist within an individual processor (e.g., a CPU). In an example, a TEE is a confidential virtual machine (CVM). CVM's can be implemented as a hardware CVM or a software CVM. In another example, a TEE is a TrustZone applet.

In some examples, the usage parameters configured by the DRM application 108 require verification of one or more security certificates before enabling execution of the AI model. In one example, multiple security certificates are chained, meaning that each certificate in the chain is signed by the entity identified in the next certificate in the chain. Chaining security certificates enables complex security surrounding execution of the AI model which may be needed when certain sensitive data is processed by the model.

Server computing system 102 further comprises an encryption module 110 and a certification module 112. While illustrated separately, it is appreciated that in certain examples, the encryption module 110 and/or the certification module 112 may be combined and/or may be part of the server DRM application 108. The encryption module 110 is configured to encrypt the AI model (and/or the model key, data associated with the AI model, etc.) for secure transmission to a client computing device 116 for execution at the client computing device 116. The encryption module 110 can use symmetric encryption (using a single key for both encryption and decryption) and/or asymmetric encryption (e.g., using a pair of keys (one public and one private), using multiple keys (a single public key and multiple private keys), etc.). It is appreciated that in certain other examples, other encryption methodologies can be employed. In one example, a subset-difference broadcast encryption methodology is used, where the server computing system 102 can securely transmit encrypted model data to plurality of external sources (e.g., client computing device 116 and other client computing devices) without individually encrypting the model for each device. When using subset-difference encryption, the server computing system 102 can efficiently encrypt model data such that only a selected subset of devices provisioned with device specific keys can calculate a key to unwrap the model key.

In one example, once a secure connection (e.g., a secured transport layer security (TLS) channel) is made between the server computing system 102 and the client computing device 116, the server computing system 102 and the client computing device 116 will exchange public keys. In some examples, network traffic between the server computing system 102 and the client computing device 116 is encrypted using respective encryption keys. In an example, the server computing system 102 uses asymmetric encryption to encrypt a model key (e.g., a model AES encryption key) using a public key of the client computing device 116 (e.g., RSA, ECC, etc.). The model key may then be decrypted at the client computing device 116 using the client computing device 116's corresponding private key.

In one example, the server computing system 102 encrypts a model key (M) (e.g., a symmetric encryption model key, such as a model AES key, or an asymmetric decryption model key (e.g., public RSA key, public ECC key, etc.)). The wrapped model key (once decrypted) can be used to access certain aspects of the AI model, for example, by decrypting the AI model (or portions thereof, for example, according to a licensed access level). In some examples, the server computing system 102 uses the client computing device 116's public key (C_{pub}) (e.g., public encryption key (RSA, ECC, etc.)) to encrypt the model key resulting in an encrypted model key, represented as ENC(C_{pub}, M). This encrypted (or wrapped) model key may then be decrypted (unwrapped) at the client computing device 116 using the client computing device 116's corresponding private key (asymmetric encryption), represented as DEC(Cₚᵣᵢ, ENC(C_{pub}, M)) [symbol] M.

In another example, the model key M is encrypted at the server computing system 102 using a first layer of encryption (e.g., using the client computing device 116's public key, C_{pub}) and a second layer of encryption (e.g., using the server computing system 102's private key, Sₚᵣᵢ). This double-encrypted (or doubly wrapped) model key is then able to be decrypted at the client computing device 116 using the client computing device 116's private key, Cₚᵣᵢ and the server computing system 102's public key, S_{pub}. The double wrapping may be done in either order, such as ENC(C_{pub}, ENC(Sₚᵣᵢ, M)) or ENC(Sₚᵣᵢ, ENC(C_{pub}, M)), with the unwrapping occurring in the corresponding inverse order to obtain the model key, e.g., DEC(S_{pub}, DEC(Cₚᵣᵢ, ENC(C_{pub}, ENC(Sₚᵣᵢ, M)))), or DEC(Cₚᵣᵢ, DEC(S_{pub}, ENC(Sₚᵣᵢ, ENC(C_{pub}, M)). Additional layers of wrapping (and unwrapping) may be applied. It is appreciated that the various encryption/decryption methodologies described herein may be applied to any data transmitted between the server computing system and one or more computing devices.

In some examples, the AI model itself is encrypted using a first type of encryption and its corresponding model key is encrypted using a second type of encryption. In some examples, the model key may be unique per client computing device 116 or generic to the provider of the AI model. In certain examples, the encryption key is hardware enforced by hardware of the client computing device 116 and/or by a software configuration state of the client computing device 116 (client operating system configuration, etc.).

The certification module 112 enables certification and/or configuration information to be associated with an AI model. In some examples, the certification module 112 is part of the server DRM application 108. In one example, the certification module 112 generates a digital signature for an AI model. In some examples, the certification module 110 generates a digital certificate that attaches the digital signature to an entity (e.g., the owner and/or provider of the AI model, the owner and/or provider of data that will be ingested into the model, etc.). The digital signature and/or digital certificate can be verified during validation of the model by the client computing device 116 (e.g., using SHA 512). In some examples, certificates and/or digital signatures may be chained together to create dependencies between each level of the chain resulting in increased security.

In certain examples, the certification module 112 is used (e.g., by the server DRM application 108) to set configuration parameters to the control the execution environment permitted to access an AI model, such as control what type of components are required to execute an AI model (e.g., number processor cores, type of processors (GPU, NPU, etc.), amount of available memory, type of memory, security requirements, etc.), what features of the AI model may be accessed, how the AI model may interact with other devices and/or applications, etc. In one example, the configuration parameters may define a user privileged access level. For example, depending on a user privilege level (e.g., as defined by a license, device resources, device configuration parameters, etc.) different functionalities or behaviors of an AI model may be authorized while others may be restricted. In one example, a client computing device with limited hardware resources (as attested by the server computing system 102) may receive the same encrypted model as a different client computing device with high performance hardware and substantial available execution resources; however, the keys provided to each different client computing device will enable different levels of functionality of the AI model (e.g., certain functionalities demanding significant resources are blocked from the client computing device with limited resources). In another example, two different client computing devices may receive the same encrypted AI model from the server computing system 102, however the respective model key received by each client computing device will unlock a different suite of features of the AI model (e.g., according to a license and/or certification). In other examples, the configuration parameters may limit the number of active users with access to the AI model, the types of data that can be logged by the client computing device 116, etc.

In one example, the model key and the model certification information are transmitted separately from the AI model payload (which comprises the AI model and any additional data associated with the model). When the model payload is transmitted to/downloaded by the client computing device 116, the client computing device 116 can validate the AI model. Validation of the AI model can include, for example, verifying one or more attestations of the model, verifying one or more certificates associated with the model, verifying an access level associated with the model (e.g., according to one or more licenses), verifying a digital signature of the model, verifying an execution environment of the client computing device, etc. In some examples, validation allows the client computing device to verify that the downloaded AI model is the authentic version of the model that was requested. In some examples, validation of the AI model by the client computing device 116 can detect that the model has been modified or otherwise tampered with, which may be indicative of malicious activity. In another example, validation of the AI model confirms that the client computing device can operate the appropriate execution environment needed to access the AI model.

Server computing system 102 further comprises an AI model data store 114. Data store 114 stores different AI models that can be transmitted to external computing systems for local execution (e.g., client computing device 116). In some examples, the server computing system 102 stores models that are designed in whole or in part by third parties. It is appreciated that the technologies herein are readily adaptable for use with AI models owned and/or developed by the provider as well as third parties. In some examples, the AI models stored in data store 114 may be optimized or otherwise modified by the model provider (e.g., by way of server DRM application 108) for execution on a client computing device 116. In some examples, server computing system 102 may modify an AI model stored in AI model data store 114 for execution on a specific external computing device (e.g., client computing device 116). More specifically, server computing system 102 may modify an AI model to take advantage of certain hardware or software capabilities of the specific computing device. In one example, an AI model may require a higher security bar and be optimized ahead of time (AOT optimization) at the server computing system 102 such that the AI model (upon successful download, storage, and decryption at the client computing device 116) can execute without the need for further configuration and/or optimization at the client computing device 116.

In another example, an AI model (e.g., a “stock” version of a model) can be optimized just-in-time (JIT optimization) at the client computing device to take advantage of specific resources available at the client computing device. In another example, an AI model may be JIT optimized based on a corresponding key or license restriction, such that the JIT optimization includes an intentional reduction of accuracy of the model.

Server computing system 102 is configured to securely transmit one or more AI models to client computing device 116 by way of network 101. As described herein, the network connection between server computing system 102 and client computing device 116 need only be active during the transmission of the AI model. In some examples, the AI model is transmitted as part of an AI model payload. The AI model payload may comprise certain data that is related to the operation of the AI model, even if it is not part of the model itself.

Client computing device 116 comprises a processor 118 and a secure processor 120. The processors 118 and 120 may be any computer processor such as a central processing unit (CPU), a graphics processing unit (GPU), neural processing unit (NPU), or the like. Processors 118 and 120 each include one or more processor cores to process computer-executable instructions, such that, when executed, cause the processor to perform certain functionality as described with reference to client computing device 116. In some examples, secure processor 120 may comprises one or more processors (of the same or different type). Depending on the application, processor 118 and secure processor 120 may be suitable for executing instructions separately or in combination. In some examples, processor 118 and secure processor 120 may execute different sets of instructions and perform operations of computing system 102 concurrently or substantially concurrently.

In an example, the secure processor 120 is any processor that is not responsible for execution of operating system instructions of client computing device 116. By remaining separate from the operating system, the security of secure processor 120 is enhanced, as it may securely execute instructions (e.g., instructions stored in a secured memory) without being exposed to vulnerabilities, such as, for example, a compromised operating system. In one example, client computing device 116 has a first processor (e.g., processor 118) and one or more second processors (e.g., 120). In some examples, the first processor is a central processing unit (CPU). In certain examples, the one or more second processors is at least one of a graphical processing unit (GPU) or a neural processing unit (NPU). In some examples, the first processor and the one or more second processor may be distinctive cores of a single processor, so long as the distinctive cores are not in operable communication with one another. In one example, the one or more second processors form a trusted execution environment (TEE). A TEE is isolated from the main operating system and other applications which prevents interaction between these aspects of the client computing device and the AI model being executed within the TEE.

The client computing device further comprises a memory 122 and a secure memory 128. Memory 122 and/or secure memory 128 may be any volatile or non-volatile memory device or combination of memory devices. In some examples, memory 122 and/or secure memory 128 comprise at least one of a dynamic random access memory (DRAM) device, a static random access memory (SRAM) device, flash memory device, phase-change memory device, or some other memory device suitable to serve as process memory. In some examples, memory 122 and secure memory 128 are distinct memory components (e.g., secure memory 128 is a dedicated GPU memory, etc.). In other examples, secure memory 128 is a part of memory 122 that is partitioned or otherwise separated from other part of memory 122. In an example, a portion of memory 122 is encrypted to create secure memory 128. The encrypted secure memory 128 may then be accessible by client computing device 116 according to usage parameters of a TEE comprising the secure memory 128. In one example, secure memory 128 is only accessible for a given virtual machine identifier (VMID), address-spaced identifier (ASID), etc. In some examples, access to secure memory 128 is policy enforced (e.g., by hardware configuration, software configuration, hypervisor, etc.).

Memory 122 stores a client application 124. The client application 124 comprises instructions, that when executed by the processor 118 and/or the secure processor 120 cause the executing processor to perform functionality associated with the client application 124. In one example, the client application 124 comprises a user interface wherein input can be received at the client computing device 116 and provided as input into the AI model. In an example, input intended for the AI model is received at the client computing device 116 by way of the client application 124. Responsive to receiving the input, the secure processor 120 executes instructions to execute the AI model and provide the input to the AI model. The secure processor may then execute the AI model (e.g., by providing the input into the model) and obtain an output of the model. The output can then be stored at the secure memory 128 and/or memory 122. In some examples, the output may be caused to be displayed by way of the client application 124 (e.g., by way of the same or similar interface that was used to provide the input). In another example, executing the AI model may encompass accessing an AI model and causing another device and/or application associated with client computing device 116 to process input and generate an output (e.g., by way of one or more aspects of the AI model).

In some examples, the client application 124 further comprises an interface that enables the submission of a request for AI model access to the server computing system 102. In some examples, memory 122 is system memory of the client computing device 116 while secure memory 128 is a secure memory not accessible certain parts of the client computing device 116 (e.g., processor 118). In some examples, the secure memory 128 is associated with the secure processor 120 (e.g., the secure processor is a GPU with dedicated GPU memory, an NPU with dedicated NPU memory, etc.).

By dividing certain execution tasks between the processor 118 and the secure processor 120, the AI model can be executed by the client computing device 116 securely without exposing sensitive portions of the model to less secure areas of the client computing device 116. Client computing device 116 further comprises validation module 126, by which the client computing device 116 can validate the AI model. Validation of the AI model can include, for example, verifying one or more attestations of the model, verifying one or more certificates associated with the model, verify an access level associated with the model (e.g., according to one or more licenses), verifying a digital signature of the model, verifying an execution environment of the client computing device, etc. Validation allows the client computing device 116 to verify that the downloaded AI model is the authentic version of the model that was requested. In some examples, validation of the AI model by the client computing device 116 can detect that the model has been modified or otherwise tampered with, which may be indicative of malicious activity. In one example, the validation module 126 validates the AI model using a hash analysis.

Upon successfully completing the validation process, the client computing device 116 may then decrypt and store the AI model in a secure memory 128. It is appreciated that secure memory 128 may be volatile or non-volatile memory. In some examples, the decrypted AI model is stored in plaintext (unencrypted) in secure memory 128. In some embodiments, the AI model is stored in the secure memory 128 in cyphertext (encrypted) form. The digital signature and/or digital certificate can be verified during validation of the model by the client computing device 116 (e.g., using SHA 512). In an example, a certificate comprises an encrypted (signed) hash of a payload (e.g., a model key, an AI model or portion thereof, etc.) that was encrypted (signed) using the private key of the server computing system 102 (e.g., RSA, ECC, etc.).

The signed hash is “decrypted” (authenticated) by the public key and should match the plaintext hash of the payload thereby: 1) validating the integrity of the payload (the hashes wouldn't match after decryption if there was bit corruption) and 2) validate that the payload was the same as was certified by the server computing system 102 since only the server computing system 102 (e.g., AI model provider) is able to encrypt the expected hash with its private key, for all (since the decryption key is public) to authenticate. In certain examples, the certification module 112 is used (e.g., by the server DRM application 108) to set configuration parameters for execution of an AI model, such as control the execution environment permitted to access an AI model (e.g., number processor cores, type of processors (GPU, NPU, etc.), amount of available memory, type of memory, requiring the model key to be bound to or stored in a secure hardware element, etc.). In other examples, the configuration parameters may limit the number of active users with access to the AI model, the types of data that can be retained by the client computing device 116, the functionality of the model (e.g., according to a user privilege level, license level, etc.). In some examples, the AI model stored in secure memory 128 is encrypted-at-rest, such that even unauthorized access to the secure memory 128 would not expose the data of the AI model. In another example, the AI model stored in secure memory 128 is encrypted such that only a specific instance of a TEE (e.g., as set forth by configuration parameters configured by the model provider) can access the plaintext data of the AI model. In another example, the AI model stored in the secure memory 128 is encrypted such that access to the encrypted AI model data (e.g., in cyphertext form) is limited.

In some examples, client computing device 116 may comprise a plurality of client computing devices. For example, the processing workload of the secure processor 120 may be distributed across several devices with the same benefits of local execution the AI model 134 at the client computing device. For example, a plurality of client computing devices may lack connection to the Internet suitable for conventional cloud-based execution of a generative model, however, if the plurality of client computing device were operably connected by way of a local area network, the devices could perform distributed execution of the AI model across the shared processing resources of the plurality of connected client computing devices.

As will be described in greater detail below, exemplary operation of DRM system 100, by way of server computing system 102 and client computing device 116, is generally configured to be executed in two parts. First, the preparation and secure transmission of an AI model (and/or data associated with the model, a model key, etc.) by the server computing system 102 to a client computing device 116. And second, once the AI model has been downloaded at the client computing device 116, securely executing the AI model at the client computing device 116 according to the configuration parameters set forth by the model provider (e.g., by way of server DRM application 108, etc.). Optionally, according to policies set forth by the AI model provider, there may also be a revocation process wherein access to the AI model is revoked and the AI model (and/or associated data) is removed/deleted (or otherwise made inaccessible) from the client computing device 116.

During exemplary operation, the process of accessing an AI model at the client computing device begins with the client computing device 116 transmitting to the server computing system 102 (e.g., by way of network 101) a request for access to a computer-implemented AI model. The AI model can be any AI model, AI agent, or the like. In some examples, the AI model is a generative language model (GLM) such as a large language model (LLM) or a small language model (SLM). In other examples, the AI model is a computer vision model. Computer vision models can analyze image data to identify and classify objects within an image, track objects in video, or perform optical character recognition to identify textual data within an image. In another example, the AI model navigation/pathfinding model. AI navigation/pathfinding models find the optimal route for virtual agents (like characters in a game) within a given environment. AI navigation/pathfinding models model the environment as a graph (a network of interconnected nodes) and then search for the best path from a starting point to a destination. It is appreciated that while generally discussed herein with respect to AI models, in some examples, the described DRM system is equally compatible with any computer-implemented model or application. In certain examples, the AI is optimized for execution on a client computing device 116 (as opposed to execution in the cloud). In some examples, the server computing system 102 has the requested AI model available within the AI model data store 114. In other examples, the server computing system 102 may obtain the requested AI model from an external source.

Responsive to positive acknowledgement of the request from the client computing device 116, a secure network connection (e.g., over the Internet) is established between the server computing system 102 and the client computing device 116. In some examples, the secure connection is a secured transport layer security (TLS) channel. Once the secure connection is established, the server computing system 102 and the client computing device 116 exchange encryption keys. In an example, the server computing system 102 encrypts the AI model key using the encryption key received from the client computing device 116. In one example, the encrypted model key, along with certification information and/or model configuration parameters set by the provider of the AI model, are transmitted to the client computing device 116. Separately, the encrypted model payload, which comprises the AI model (and any data associated with the model), is transmitted to the client computing device 116, where the encrypted model payload is stored in secure memory 128.

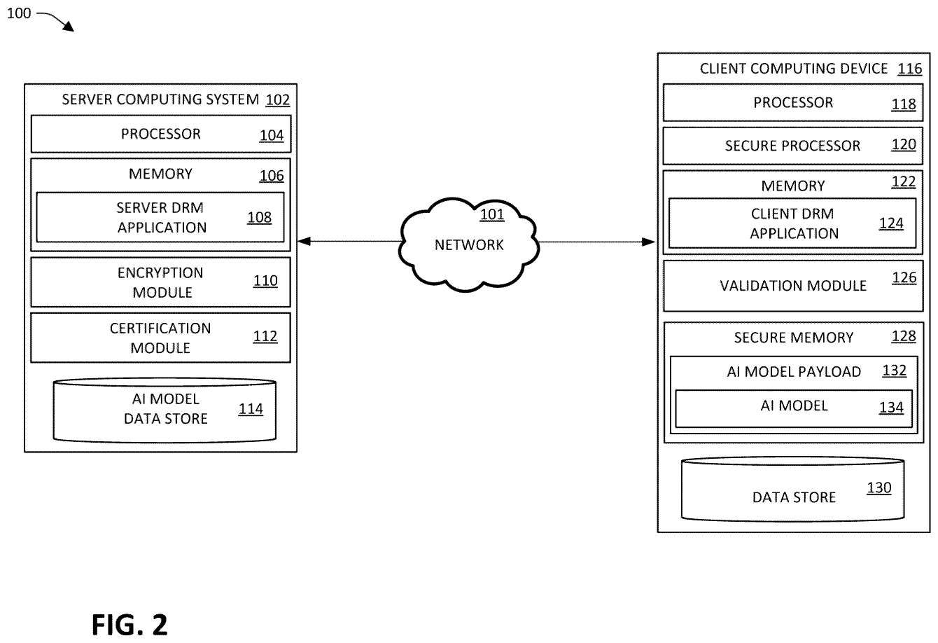

Now with reference to FIG. 2, the DRM system 100 is illustrated again, however, now the AI model payload 132 has been successfully transmitted to the client computing device 116 and is stored within the secure memory 128. In connection with the transmission of the AI model payload 132, the server computing system 102 also transmits the encrypted model key and certification and/or configuration information to the client computing device 116. In some examples, the encrypted model key and certification/configuration information are sent before the AI model payload 132. In other examples, the encrypted model key, certification/configuration information, and AI model payload 132 may be transmitted to the client computing device 116 concurrently or substantially concurrently.

The AI model payload 132 comprises at least the AI model 134. In some examples, the AI model payload 132 additionally comprises data that is associated with the model or operation thereof. In some examples, when the AI model payload 132 is received by the client computing device 116 it is double encrypted. For example, the payload is encrypted by the server computing system 102, but then as it is stored in the secure memory 128, it is inline encrypted. After successful receipt of the AI model payload 132, the client computing device validates the model (e.g., using validation module 126). As described herein, the validation module 126 may verify the digital signature of the model and/or a digital certificate associated with the model to confirm the authenticity of the model and its origin (e.g., the server computing system 102). In some embodiments, the model is validated while still being encrypted.

After the AI model payload 132 (and/or the AI model 134) is validated by the validation module 126, the client computing device 116 performs decryption of the AI model key. In an example, the server computing system 102 encrypted the AI model key using the public key received from the client computing device 116. Accordingly, only the client's private key may decrypt the encrypted model key. Once the model key is decrypted, the AI model payload may be decrypted and safely stored in the secure memory 128. In some embodiments, the AI model payload is inline encrypted as it is stored in the secure memory 128 (even after it has been decrypted with its corresponding model key). The model is then ready to be securely accessed by the secure processor 120 for model execution.

To execute the AI model 134 stored in the secure memory 128, the processor 118 (e.g., CPU) sends a request by way of an application (e.g., a client DRM application 124) to the secure processor 120 (e.g., GPU, NPU, etc.) that is configured to execute the AI model 134. The request may include information relating to the model such as which model needs to be executed (e.g., the name or identifier associated with the model), how much memory is needed for execution of the model, etc. The secure processor 120 then reads model parameters from the secure memory 128 and causes execution of the model. In another example, the secure processor 120 securely accesses model information (e.g., model weights, configuration information, operation parameters, etc.) and uses the model information to configure a device and/or application to process inputs using the model information and generate output data. In some examples, the information retrieved from the secure memory 128 is inline decrypted while being read. In certain examples, the secure processor 120 executes certain functionality of the AI model 134 using information stored in the secure memory 128 and information stored in other memory associated with client computing device (e.g., memory 122). The resulting output of the AI model is then stored at the client computing device 116, either in secured memory 128 and/or in other (e.g., non-secured) memory (e.g., memory 122 and/or data store 130).

In some examples, as the AI model is executed at client computing device 116, the model learns on each activation. These parameters/relearning parts of the model become part of the protected content stored at secure memory 128. Moreover, the learned data of the AI model 132 (and/or the AI model 132 itself) can be force deleted or otherwise made inaccessible upon violation of configuration parameters associated with the AI model (e.g., as set forth by the model provider) and/or detection of a security vulnerability/security breech. In some examples, access to AI model 132 may be limited according to certification information. In certain examples, access to the AI model 132 may be revoked or otherwise modified according to the certification information (e.g., a detected expiration of a license, etc.).

It is a further aspect of the described technologies that certain elements of the execution of an AI model are exposed to the executing processor (e.g., secure processor 120) and not exposed to processor 118. According to some examples, an exemplary list of elements and their exposure to each of processor 118 and secure processor 120 during execution of AI model 134 is listed below:

| | Exposure to | Exposure to Secure |
|---|---|---|
| | Processor 118 | Processor 120 |
| Model Graph | No | Yes |
| Model Weights | No | Yes |
| Execution Commands | No | Yes |
| Model Label | Yes | Yes |
| Model Priority | Yes | Yes |
| Processor ID | Yes | Yes |
| Memory Size | Yes | Yes |
| Memory Chunk Order | Yes | Yes |

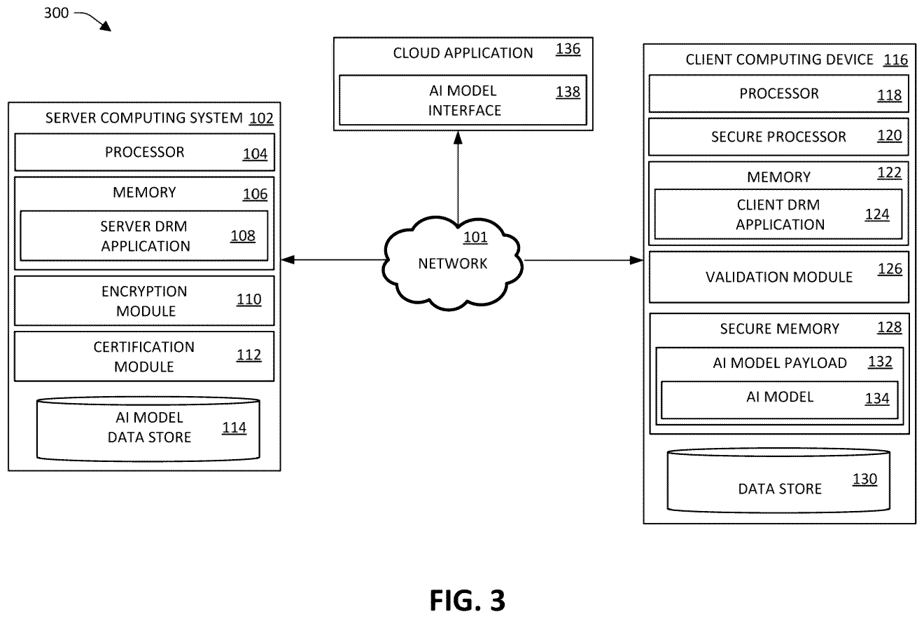

Now with reference to FIG. 3, an exemplary DRM system 300 is illustrated. System 300 comprises a server computing system 102 and a client computing device 116 as well as a cloud application 136. The cloud application 136 executes an AI model interface 138 for interaction with AI model 134. In an example, a user of client computing device 116 sets forth input for the AI model 134 by way of the AI model interface 138 being executed in the cloud application 136. The cloud application 136 may then securely transmit the input to the client computing device 116 and the input can be processed by the secure processor 120. Specifically, to execute the AI model 134 stored in the secure memory 128, the cloud application 136 sends a request to the secure processor 120 (e.g., GPU, NPU, etc.) that is configured to cause execution of the AI model 134. The request may include information relating to the model such as which model needs to be executed (e.g., the name or identifier associated with the model), how much memory is needed for execution of the model, etc. The secure processor 120 then reads model parameters from the secure memory 128 and executes the model. In some examples, the information retrieved from the secure memory 128 is inline decrypted while being read. In certain examples, the secure processor 120 executes certain functionality of the AI model 134 using information stored in the secure memory 120 and information stored in other memory associated with client computing device (e.g., memory 122). The resulting output of the AI model 134 is then transmitted back to the AI model interface 138 for display at the cloud application 136. In such an example, the efficiency and security gains of local execution the AI model 134 are coupled with the interoperability with existing web-based application interfaces.

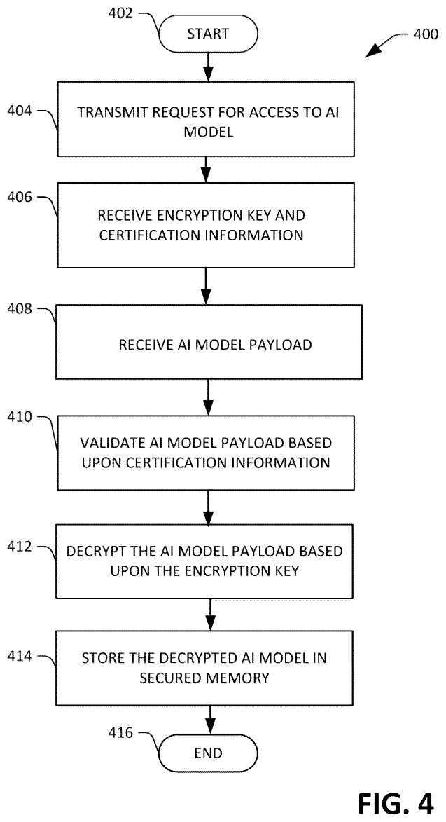

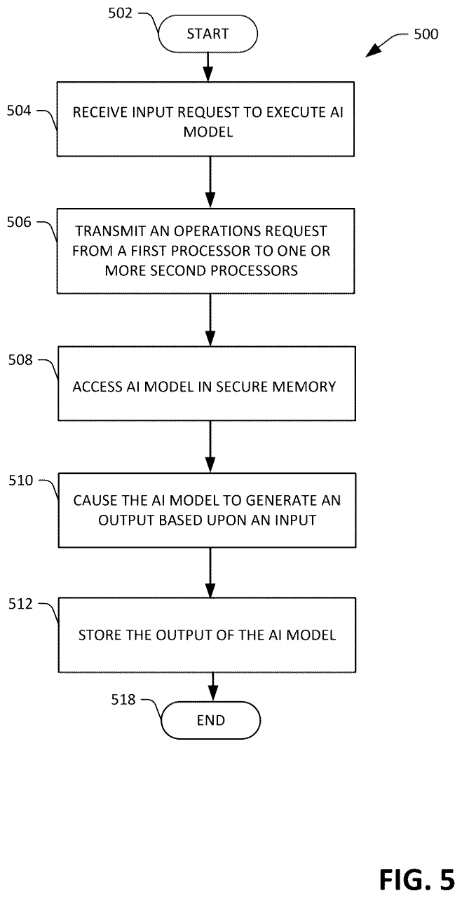

FIGS. 4 and 5 illustrate example methodologies relating to the secure download and execution of an AI model to a client computing device as described herein. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 4, an example methodology 400 related to storage of an AI model asset is illustrated. The methodology starts at step 402. At step 404 a request for access to an AI model is transmitted (e.g., from client computing device 116 to server computing system 102). At step 406 a model key and certification information are received. In certain examples, the model key is encrypted using asymmetric encryption. In some examples, responsive to receiving the request for access to the AI model, the server computing system 102 establishes a secure connection with the client computing device 116. In some examples, the model key and certification information are received by way of the secure connection.

At 408, the AI model payload is received. The AI model payload may comprise the AI model and additional data related to execution of the AI model. It is appreciated that execution of the AI model encompasses accessing one or more aspects of the AI model (e.g., model parameters, model weights, and/or other model data) to cause the AI model to generate output. At step 410, the AI model is validated (e.g., by way of validation module 126). Validating the AI model may comprise verifying a digital signature and/or digital certificate associated with the AI model. Validating the AI model may further comprise verifying one or more attestations of the AI model. At step 412, the AI model is decrypted based upon the model key received at step 406. In some examples, the model key is encrypted and must be decrypted before being used to access the AI model. At step 414, the decrypted AI model is stored in secured memory (e.g., secure memory 128).

The methodology 400 ends at step 416.

Referring now to FIG. 5, an example methodology 500 related to local execution of an AI model (e.g., at client computing device 116) is illustrated. The methodology starts at step 502.

At step 504, an input request is received relating to execution of the AI model. It is appreciated that execution of the AI model encompasses accessing one or more aspects of the AI model (e.g., model parameters, model weights, and/or other model data) to cause the AI model to generate output. As described herein the input request may originate as input at a local interface (e.g., by way of client application 124) or web application 136. Upon receiving the input request, at step 506 an operations request is sent from a first processor to one or more second processors that are configured to execute the AI model.

At step 508, the AI model is accessed in the secure memory (e.g., by the one or more second processors, secure processor 120). By way of execution, at step 510, the AI model is caused to generate an output based upon an input associated with the input request. At step 512, the output of the AI model is stored (e.g., at secure memory 128, data store 130, and/or memory 122). In some examples, the output of the AI model is stored external to the computing system storing the AI model. The methodology 500 ends at step 518.

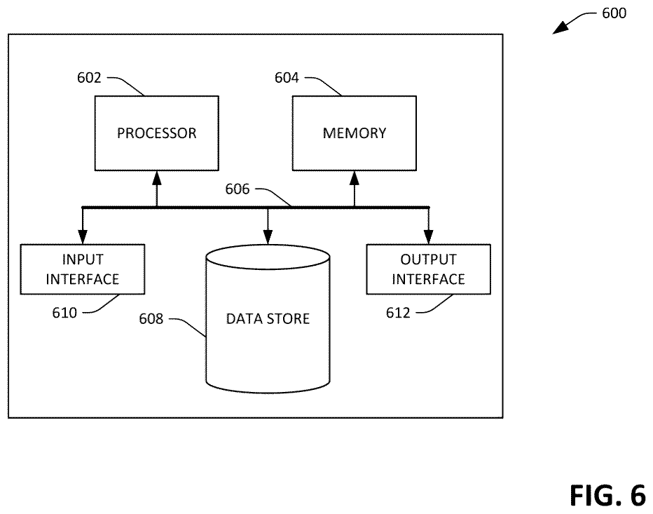

Referring now to FIG. 6, a high-level illustration of an example computing device 600 that can be used in accordance with the systems and methodologies disclosed herein is illustrated (e.g., computing system 102, client computing system 120, testing computing system 130, etc.). The computing device 600 includes at least one processor 602 that executes instructions that are stored in a memory 604. The instructions may be, for instance, instructions for implementing functionality described as being carried out by one or more components discussed above or instructions for implementing one or more of the methods described above. The processor 602 may access the memory 604 by way of a system bus 606.

The computing device 600 additionally includes a data store 608 that is accessible by the processor 602 by way of the system bus 606. The data store 608 may include executable instructions, computer-readable text that includes words, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

It is contemplated that the external devices that communicate with the computing device 600 by way of the input interface 610 and the output interface 612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 600 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 600 may be a distributed system. Thus, for instance, several devices may be in communication by way of a network connection and may collectively perform tasks described as being performed by the computing device 600.

The present disclosure relates to digital rights management for AI models that enables secure transmission and local execution of an AI model at a client computing device. Exemplary operation of a client computing device is described according to at least the following examples:

(A1) In one aspect, some embodiments include a method (e.g., 400, 500) executed by at least one processor (e.g., processor 118, secure processor 120) of a computing system (e.g., client computing device 116). The method comprises transmitting, to a server computing system (e.g., server computing system 102), a request for access to a computer-implemented artificial intelligence (AI) model. The method further comprises receiving, from the server computing system, an encryption key, AI model certification information, and an AI model payload, wherein the AI model payload comprises an encrypted AI model. The method further comprises validating the AI model payload based upon the AI model certification information. The method additionally comprises decrypting the AI model payload. The method further comprises storing the decrypted AI model payload in a secure memory. The method additionally comprises requesting execution of the AI model stored in the secure memory. The method further comprises causing execution of the AI model by the one or more secure processors.

(A2) According to some embodiments of the method of A1, the one or more secure processors comprise at least one of a graphical processing unit (GPU) or a neural processing unit (NPU).

(A3) According to some embodiments of any of the methods of (A1)-(A2), validating the AI model payload comprises verifying at least one of a digital signature of the AI model or a digital certification of the AI model.

(A4) According to some embodiments of any of the methods of (A1)-(A3), the encryption key is a content key associated with the AI model payload, wherein the encryption key is encrypted by the server computing system using asymmetric encryption.

(A5) According to some embodiments of any of the methods of (A1)-(A4), the execution of the AI model comprises receiving an input, providing the input to the AI model, causing the AI model to generate an output based upon the input, and storing the output of the AI model.

(A6) According to some embodiments of any of the methods of (A1)-(A5), the input is received by way of an AI model interface executed on a cloud application.

(A7) According to some embodiments of any of the methods of (A1)-(A6), the at least one of the one or more second processors is associated with a second client computing device, wherein execution of the AI model is distributed among at least the first and second client computing device.

(A8) According to some embodiments of any of the methods of (A1)-(A7), wherein during execution of the AI model, model parameters retrieved from the second memory are inline decrypted.

(A9) According to some embodiments of any of the methods of (A1)-(A8), the input is received by way of an AI model interface executed on a cloud application.

(A10) According to some embodiments of any of the methods of (A1)-(A9), the first processor is prevented from accessing the AI model stored in the secure memory.

(A1 l) According to some embodiments of any of the methods of (A1)-(A10), the AI model is a generative language model.

(B1) In another aspect, some embodiments include a client computing device (e.g., client computing device 116) that includes at least one processor (e.g., processor 118, secure processor 120, etc.) and memory (e.g., memory 122). The memory stores instructions (e.g., client DRM application 124) that, when executed by the processor, cause the processor to perform any of the methods described herein (e.g., any of A1-A11).

(C1) In yet another aspect, some embodiments include a non-transitory computer-readable storage medium that includes instructions that, when executed by a processor (e.g., processor 104 of computing system 102), cause the processor to perform any of the methods described herein (e.g., any of A1-A11).

(D1) In yet another aspect, some embodiments include a client computing device (e.g., client computing device 116) comprising a first processor (e.g., processor 118) and one or more second processors (e.g., secure processor 120). The client computing device further comprises a first memory (e.g., memory 122) and a second memory (e.g., secure memory 128) wherein the first memory has a digital rights management (DRM) application stored therein, wherein when the DRM application is executed by the first processor, the DRM application causes the client computing device to perform certain acts. The acts comprise at least transmitting, to a server computing system (e.g., server computing system 102), a request for access to a computer-implemented artificial intelligence (AI) model (e.g. AI model 134). The acts additionally comprise receiving, from the server computing system, an encryption key, AI model certification information, and an AI model payload, wherein the AI model payload comprises an encrypted AI model. The acts additionally comprise validating the AI model payload based upon the AI model certification information. The acts further comprise decrypting the AI model payload. The acts additionally comprise storing the decrypted AI model payload in the second memory. The acts further comprise requesting execution of the AI model stored in the second memory and causing execution of the AI model by the one or more second processors.

(D2) According to some embodiments of the client computing device of D1, the one or more secure processors comprise at least one of a graphical processing unit (GPU) or a neural processing unit (NPU).

(D3) According to some embodiments of any of the client computing devices (D1)-(D2), validating the AI model payload comprises verifying at least one of a digital signature of the AI model or a digital certification of the AI model.

(D4) According to some embodiments of any of the client computing devices (D1)-(D3), the encryption key is a content key associated with the AI model payload, wherein the encryption key is encrypted by the server computing system using asymmetric encryption.

(D5) According to some embodiments of any of the client computing devices (D1)-(D4), the execution of the AI model comprises receiving an input, providing the input to the AI model, causing the AI model to generate an output based upon the input, and storing the output of the AI model.

(D6) According to some embodiments of any of the client computing devices (D1)-(D5), the input is received by way of an AI model interface executed on a cloud application.

(D7) According to some embodiments of any of the client computing devices (D1)-(D6), the at least one of the one or more second processors is associated with a second client computing device, wherein execution of the AI model is distributed among at least the first and second client computing device.

(D8) According to some embodiments of any of the client computing devices (D1)-(D7), wherein during execution of the AI model, model parameters retrieved from the second memory are inline decrypted.

(D9) According to some embodiments of any of the client computing devices (D1)-(D8), the input is received by way of an AI model interface executed on a cloud application.

(D10) According to some embodiments of any of the client computing devices (D1)-(D9), the first processor is prevented from accessing the AI model stored in the secure memory.

(D11) According to some embodiments of any of the client computing devices (D1)-(D10), the AI model is a generative language model.

Various functions described herein can be implemented in hardware, firmware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers.

Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware and/or software logic components. For example, and without limitation, illustrative types of hardware logic components that can be used include, but are not limited to, Central Processing Unit (CPU), Graphical Processing Units (GPUs), Neural Processing Units (NPUs), Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. In some examples, certain hardware logic components (and/or their associated functionality) may be implemented by way of one virtual machines to implement and execute the various technologies described herein.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, “model” and “system” are intended to encompass computer-executable instructions that cause certain functionality to be performed when executed by one or more processors. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A client computing device, comprising:
a first processor;
one or more second processors; and
a first memory and a second memory, wherein the first memory has a digital rights management (DRM) application stored therein, wherein when the DRM application is executed by the first processor, the DRM application causes the client computing device to perform acts comprising:
transmitting, to a server computing system, a request for access to a computer-implemented artificial intelligence (AI) model;
receiving, from the server computing system, an encryption key, AI model certification information, and an AI model payload, wherein the AI model payload comprises an encrypted AI model;
validating the AI model payload based upon the AI model certification information;
decrypting the AI model payload;
storing the decrypted AI model payload in the second memory;
requesting execution of the AI model stored in the second memory; and
causing execution of the AI model by the one or more second processors.

2. The client computing device of claim 1, wherein the first processor is a central processing unit (CPU) and the one or more second processors comprise at least one of a graphical processing unit (GPU) or a neural processing unit (NPU).

3. The client computing device of claim 1, wherein validating the AI model payload comprises verifying at least one of a digital signature of the AI model or a digital certification of the AI model.

4. The client computing device of claim 1, wherein the encryption key is a content key associated with the AI model payload, wherein the encryption key is encrypted by the server computing system using asymmetric encryption.

5. The client computing device of claim 1, wherein during execution of the AI model, model parameters retrieved from the second memory are inline decrypted.

6. The client computing device of claim 1, wherein execution of the AI model comprises:
receiving an input;
providing the input to the AI model;
causing the AI model to generate an output based upon the input; and
storing the output of the AI model.

7. The computing system of claim 6, wherein the input is received by way of an AI model interface executed on a cloud application.

8. The computing system of claim 1, wherein at least one of the one or more second processors is associated with a second client computing device, wherein execution of the AI model is distributed among at least the first and second client computing device.

9. The computing system of claim 1, wherein the first processor is prevented from accessing the AI model stored in the secure memory.

10. The computing system of claim 1, wherein the AI model is a generative language model.

11. A method, the method comprising:
transmitting, to a server computing system, a request for access to a computer-implemented artificial intelligence (AI) model;
receiving, from the server computing system, an encryption key, AI model certification information, and an AI model payload, wherein the AI model payload comprises an encrypted AI model;
validating the AI model payload based upon the AI model certification information;
decrypting the AI model payload;
storing the decrypted AI model payload in a secure memory;
requesting execution of the AI model stored in the secure memory; and
causing execution of the AI model by the one or more secure processors.

12. The method of claim 11, wherein the one or more secure processors comprise at least one of a graphical processing unit (GPU) or a neural processing unit (NPU).

13. The method of claim 11, wherein validating the AI model payload comprises verifying at least one of a digital signature of the AI model or a digital certification of the AI model.

14. The method of claim 11, wherein the encryption key is a content key associated with the AI model payload, wherein the encryption key is encrypted by the server computing system using asymmetric encryption.

15. The method of claim 11, wherein execution of the AI model comprises:
receiving an input;
providing the input to the AI model;
causing the AI model to generate an output based upon the input; and
storing the output of the AI model.

16. The method of claim 15, wherein the input is received by way of an AI model interface executed on a cloud application.

17. The method of claim 11, wherein at least one of the one or more second processors is associated with a second client computing device, wherein execution of the AI model is distributed among at least the first and second client computing device.

18. A non-transitory computer-readable storage medium comprising instructions that, when executed by a processor of a computing system, cause the processor to perform acts comprising:
transmitting, to a server computing system, a request for access to a computer-implemented artificial intelligence (AI) model;
receiving, from the server computing system, an encryption key, AI model certification information, and an AI model payload, wherein the AI model payload comprises an encrypted AI model;
validating the AI model payload based upon the AI model certification information;
decrypting the AI model payload;
storing the decrypted AI model payload in the second memory;
requesting execution of the AI model stored in the second memory; and
causing execution of the AI model by the one or more second processors.

19. The non-transitory computer-readable storage medium of claim 18, wherein execution of the AI model comprises:
receiving an input;
providing the input to the AI model;
causing the AI model to generate an output based upon the input; and
storing the output of the AI model.

20. The non-transitory computer-readable storage medium of claim 19, wherein at least one of the one or more second processors is associated with a second client computing device, wherein execution of the AI model is distributed among at least the first and second client computing device.
